(19) United States
(12) Patent Application Publication
(10) Pub. No.: US 2010/0095600 A1
(43) Pub. Date: Apr. 22, 2010

(54) AUTOMOTIVE WINDOW ASSEMBLY

(75) Inventors: Marcel Gagnon, Magog (CA); Nicholas Talbot, Sherbrooke (CA); Shawn Jyawook, Ann Arbor, MI (US); Jim Browell, Ann Arbor, MI (US)

Correspondence Address: BROOKS KUSHMAN P.C., 1000 TOWN CENTER, TWENTY-SECOND FLOOR, SOUTHFIELD, MI, 48075, US

(73) Assignee: JYCO SEALING TECHNOLOGIES, Dexter, MI (US)

(21) Appl. No.: 12/582,256

(22) Filed: Oct. 20, 2009

Related U.S. Application Data
(60) Provisional application No. 61/106,712, filed on Oct. 20, 2008.

(51) Int. Cl. E06B 7/16; E06B 3/00

(52) U.S. Cl. 49/493.1; 49/506

(57) ABSTRACT

A window assembly for an automotive vehicle includes a division post formed by a co-extrusion process to include integrally-formed window pane seals. Upper and lower ends of the division post are joined or assembled to a flexible seal band such that the post and seal band completely surround a fixed window pane. The window assembly is simple and inexpensive to manufacture.

### CROSS-REFERENCE TO RELATED APPLICATIONS

This application claims the benefit of U.S. provisional application Ser. No. 61/106,712 filed Oct. 20, 2008.

### BACKGROUND

1. Field

The invention relates to window assemblies as used in automotive applications, and more specifically to a window assembly for supporting and guiding both a fixed window pane and a movable window pane.

2. Background Art

A modern automobile includes a number of windows located on the left and right sides of the passenger compartment. These side windows may be incorporated into a fixed portion of the vehicle body or into a movable door used to ingress/egress the vehicle. Door-mounted windows typically involve at least one movable window pane (slidable between open and closed positions in a generally vertical plane of motion) and at least one fixed window pane adjacent to the movable pane. The fixed window pane my also be mounted to the vehicle body adjacent to the door, as opposed to the door itself. A division post separates and supports adjacent edges of the movable and fixed window panes and serves as a guide for the movable pane as it moves between open and closed positions. The division post also serves as a weather seal between the movable and fixed panes, keeping rain and other environment elements out of the passenger compartment and reducing the presence of wind noise inside the vehicle.

Conventionally, the division post has comprised a metal section, usually formed by roll-forming, stretch-bending, and/or extrusion, having a cross section in the general shape of an H. The flanges of the H define a pair of channels running along opposite sides of the post. First and second elongated, flexible seals are retained in the channels, the first seal securely holding the edge of the fixed window pane and the second seal contacting the edge of the movable window pane and supporting it to allowing vertical sliding movement relative to the division post.

There are several disadvantages related to the division post described above. Among these disadvantages are: Relatively high weight, the need to paint the exposed portions of the metal division post, overall complexity and cost associated with assembling the components, difficulty in achieving proper fit between the various components of the assembly, poor recyclability of the parts, and undesirable impact on the environment related to the manufacturing processes.

### SUMMARY

According to a first aspect of the disclosed embodiment of the invention, an automotive vehicle window assembly comprises a division post having an upper end and a lower end and comprising a rigid core, a pair of fixed pane seal lips extending along a first edge of the division post, and a pair of sliding pane seal lips extending along a second edge of the division post. The assembly further comprises a seal band having a first end secured to the division post adjacent its upper end and a second end secured to the division post adjacent its lower end. The seal band includes a seal edge oriented toward the division post such that the seal edge and the fixed pane seal lips form a peripheral seal. The window assembly may further comprise a window pane having an outer edge is surrounded and sealingly engaged by the peripheral seal.

The disclosed window assembly is simple and inexpensive to manufacture and solves other shortcomings associated with prior window assemblies of this type.

An inner one of the fixed pane seal lips and an inner one of the sliding pane seal lips may be formed as part of an inner coat disposed on a first side of the core. An outer one of the fixed pane seal lips and an outer one of the sliding pane seal lips may be formed as part of an outer coat disposed on a second side of the core.

The division post may further comprises an aluminum strip contacting the core.

The window assembly may further comprise an upper frame having a first end adjacent the upper end of the division post and extending away from the second edge of the division post. The upper frame has lower sealing edge that receives a sliding pane

According to a second aspect of the invention, a method of making an automotive vehicle window assembly comprises the steps of forming a division post having an upper end and a lower end, the post comprising a rigid core, a pair of fixed pane seals extending along a first edge of the division post, and a pair of sliding pane seals extending along a second edge of the division post opposite the first edge. The method further comprises forming a seal band having a first end secured to the division post adjacent its upper end and a second end secured to the division post adjacent its lower end, the seal band having a seal edge oriented toward the first edge of the division post such that the seal edge and the fixed pane seals form a peripheral seal. The method further comprises inserting a fixed window pane inside the peripheral seal.

The method of may further comprise forming the seal band by placing the division post in a mold and injecting a flowable material into the mold to form the seal band.

The method may further comprise placing an upper frame in the mold adjacent the upper end of the division post prior to injection of the flowable material, the flowable material contacting the upper frame. In this method, the flowable material that forms the seal band bonds with the division post and with the upper frame for form a unitary structure.

### BRIEF DESCRIPTION OF THE DRAWINGS

FIG. 1 is an elevation view of a window assembly in accordance with an exemplary embodiment of the invention; and

FIG. 2 is a cross section view taken along line 2-2 in FIG. 1.

### DETAILED DESCRIPTION OF THE PREFERRED EMBODIMENT

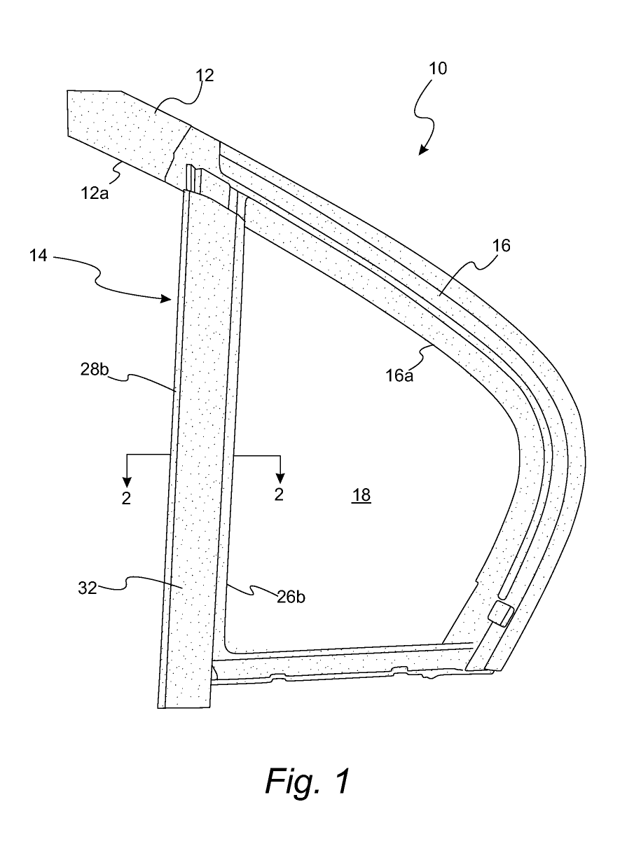

FIG. 1 illustrates an exemplary window assembly, generally indicated at 10, made in accordance with the invention. Window assembly 10 is adapted to be installed in a movable door (not shown) of a vehicle, however other embodiments of the invention may be adapted to be installed in a fixed portion of a vehicle body. Window assembly 10 comprises an upper frame 12, a division post 14, a seal band 16, and a fixed window pane 18.

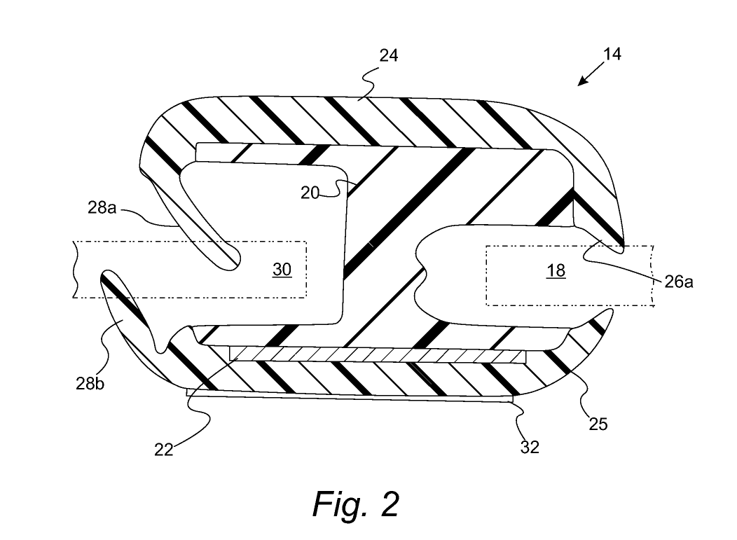

Referring now to FIG. 2, the division post 14 comprises a core 20, an aluminum strip 22, an interior coat 24 and an exterior coat 25. Core 20 is preferably composed of polypropylene, but may be composed from any suitable material. Aluminum strip 22 is provided to control shrinkage and to prevent “read-through.”

Interior and exterior coats 24, 25 are preferably composed of a flexible material such as, for example, thermoplastic vulcanizate (TPV). An inner fixed pane seal lip 26a and an inner sliding pane seal lip 28a are formed as part of interior coat 24. An outer fixed pane seal lip 26b and an outer sliding pane seal lip 28b are formed as part of outer coat 25. Fixed seal lips 26a, 26b are configured to securely engage and seal with the edge of fixed pane 18. Sliding seal lips 28a, 28b are configured to engage a lateral edge of a movable pane 30 (see FIG. 2) that slides parallel with the longitudinal axis of division post 14. It may be seen in FIG. 2 that fixed seal lips 26a, 26b are of different configurations than sliding seal lips 28a, 28b. This difference of configuration is because the two sets of seal lips are adapted for the different functions of sealing with a fixed pane and a sliding pane respectively. The configurations of such fixed and sliding seal lips are well known in the automotive glass art.

Division post 14 may be formed by a co-extrusion process of the general type well known in the art. In such a co-extrusion process, core 20, aluminum strip 22, interior coat 24, and exterior coat 25 are extruded simultaneously as a single unit such that the core 20 and coats 24, 25 chemically bond with one another and trap the aluminum strip. The resulting part is sufficiently rigid to support both fixed pane 18 and movable pane 30, and also to serve as a guide for movable pane 30 as it slides vertically (as seen in FIG. 1) between open and closed positions.

Seal band 16 is joined to upper and lower ends of division post 14 and extends completely around the periphery of fixed pane 18. Seal band 16 is composed of a flexible material such as TPV and has an integrally-formed seal edge 16a around its interior to sealingly engage the edge of fixed pane 18. Seal edge 16a comprises an opposed pair of lips (not shown) configured to permanently seal with fixed pane 18 and which may be similar in configuration to fixed seal lips 26a, 26b. Seal edge 16a and fixed seal lips 26a and 26b form a peripheral seal that surrounds fixed pane 18.

Upper frame 12 is joined to seal band 16 and extends away therefrom to mate with the upper edge of movable pane 30 when the movable pane is in the fully up or closed position. Upper frame 12 has a seal edge 12a extending along its lower edge to face generally toward division post so that the seal edge may sealingly engage the top edge of movable window pane 30. Seal edge 12a comprises a pair of opposed lips (not shown). Upper frame 12 is preferably a unitary piece formed of a flexible material such as TPV, and may be formed by an extrusion process.

Window assembly 10 may be manufactured using an open-mold process wherein the previously-formed upper frame 12 and division post 14 are placed in a mold and a flowable material, such as TPV, is injected into the mold to form the seal band 16. Materials other than TPV could be used in the alternative. The injected material contacts and bonds with upper frame 12 and division post 14 as it solidifies. The connections between seal band 16 and the other two components may also include various types of mechanical and/or thermal joining techniques, such as heat staking, ultrasonic welding, and/or interlocking brackets.

The unit described above is then removed from the open mold and fixed pane 18 is inserted into the position shown in FIG. 1 by stretching the seal band 16 outwardly away from division post 14 as necessary to allow the fixed pane 18 to be inserted between seal edge 16a and division post fixed seal lips 26a, 26b. The complete window assembly 10 may then be installed in a door or body panel of a vehicle (not shown) in the conventionally known fashion.

A film 32 may be applied to the exterior and/or interior surfaces of division post 14 to achieve a desired vehicle appearance. For example, the color and/or texture of film 32 applied over exterior coat 25 may be selected to match, contrast with, or otherwise complement the color of the main portion of the vehicle door, body, or roof (not shown). Film 32 may also be a material that provides a surface more resistant to environmental conditions than the material of exterior coat 25.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an automotive vehicle window assembly comprising:
forming a division post having an upper end and a lower end, the post comprising a rigid core, a pair of fixed pane seals extending along a first edge of the division post, and a pair of sliding pane seals extending along a second edge of the division post opposite the first edge;
forming a seal band having a first end secured to the division post adjacent its upper end and a second end secured to the division post adjacent its lower end, the seal band having a seal edge oriented toward the first edge of the division post such that the seal edge and the fixed pane seals form a peripheral seal; and
inserting a fixed window pane inside the peripheral seal.

2. The method of claim 1 wherein the step of forming the division post comprises co-extruding the core, the fixed pane seals and sliding pane seals.

3. The method of claim 2 wherein the step of forming the division post further comprises forming an aluminum strip contacting the core.

4. The method of claim 1 wherein the fixed and sliding pane seals are formed as part of an outer coat disposed on a first side of the core and an inner coat disposed on a second side of the core.

5. The method of claim 1 further comprising wherein the step of forming the seal band comprises placing the division post in a mold and injecting a flowable material into the mold to form the seal band.

6. The method of claim 5 wherein an upper frame is placed in the mold adjacent the upper end of the division post and extending away from the second edge of the division post prior to injection of the flowable material, the flowable material contacting the upper frame.

7. The method of claim 6 wherein the upper frame comprises a seal edge oriented toward the division post.

8. The method of claim 1 wherein the fixed seal lips and the sliding seal lips comprise a thermoplastic vulcanizate material.

9. The method of claim 1 wherein the seal band comprises a thermoplastic vulcanizate material.

10. An automotive vehicle window assembly comprising:
a division post having an upper end and a lower end and comprising a rigid core, a pair of fixed pane seal lips extending along a first edge of the division post, and a pair of sliding pane seal lips extending along a second edge of the division post; and
a seal band having a first end secured to the division post adjacent its upper end and a second end secured to the division post adjacent its lower end, the seal band having a seal edge oriented toward the division post such that the seal edge and the fixed pane seal lips form a peripheral seal.

11. The window assembly of claim 10 further comprising a window pane having an outer edge surrounded and sealingly engaged by the peripheral seal.

12. The window assembly of claim 10 wherein an inner one of the fixed pane seal lips and an inner one of the sliding pane seal lips are formed as part of an inner coat disposed on a first side of the core.

13. The window assembly of claim 10 wherein an outer one of the fixed pane seal lips and an outer one of the sliding pane seal lips are formed as part of an outer coat disposed on a second side of the core.

14. The window assembly of claim 10 wherein the division post core, the fixed pane seals, and sliding pane seals are formed by a coextrusion process.

15. The window assembly of claim 10 wherein the division post further comprises an aluminum strip contacting the core.

16. The window assembly of claim 10 wherein the seal band comprises a thermoplastic vulcanizate material.

17. The window assembly of claim 10 further comprising a fixed window pane surrounded by the peripheral seal.

18. The window assembly of claim 10 further comprising an upper frame having a first end adjacent the upper end of the division post and extending away from the second edge of the division post.

19. The window assembly of claim 10 further comprising a movable pane having a lateral edge slidingly received sliding pane seal lips and by an upper frame having a first end adjacent the upper end of the division post and extending away from the second edge of the division post.

20. An automotive vehicle window assembly comprising:
a division post having an upper end and a lower end and comprising a rigid core, a pair of fixed pane seal lips extending along a first edge of the division post, and a pair of sliding pane seal lips extending along a second edge of the division post;
an upper frame having a first end adjacent the upper end of the division post and extending away from the second edge of the division post, the upper frame having a seal edge oriented toward the second edge of the division post;
a movable window pane having a lateral edge engaged by the sliding pane seal lips and movable between a closed position wherein an upper edge of the movable window pane is engaged by the upper frame seal edge and an open position wherein the upper edge is spaced from the seal edge;
a seal band having a first end secured to the division post adjacent its upper end and to the upper frame adjacent its first end, the seal band further having a second end secured to the division post adjacent its lower end, the seal band having a seal edge oriented toward the division post such that the seal edge and the fixed pane seal lips form a peripheral seal; and
a fixed window pane surrounded by the peripheral seal.
